(19) United States
(12) Patent Application Publication
(10) Pub. No.: US 2015/0243116 A1
(43) Pub. Date: Aug. 27, 2015

(54) ELECTRONIC VEHICLE KEY

(71) Applicant: Craig Alexander Colburn, Longmeadow, MA (US)

(72) Inventor: Craig Alexander Colburn, Longmeadow, MA (US)

(21) Appl. No.: 14/699,013

(22) Filed: Apr. 29, 2015

Related U.S. Application Data
(63) Continuation of application No. 13/602,701, filed on Sep. 4, 2012, now Pat. No. 9,058,704.

(51) Int. Cl. G07C 9/00

(52) U.S. Cl. CPC G07C 9/00896; G07C 2009/0019

(57) ABSTRACT

An electronic vehicle key includes a controller receptive to electrical power from both conductive transmission and inductive transmission. The controller has a processor that is responsive to executable computer instructions for controlling operation of the electronic vehicle key. The electronic vehicle key also includes a passive device configured to be receptive to a field external of the electronic vehicle key for inducing an electric current in the passive device. The passive device is in communication with the controller. The controller is configured and disposed to cause the passive device to transmit a radio-frequency signal as a result of the electric current induced in the passive device. The radio-frequency signal, when received at a vehicle, will enable activation of a vehicle feature.

### CROSS REFERENCE TO RELATED APPLICATION

This application is a continuation of U.S. application Ser. No. 13/602,701 filed Sep. 4, 2012, the disclosure of which is incorporated by reference herein in its entirety.

### BACKGROUND OF THE DISCLOSURE

The subject matter disclosed herein relates to an electronic key for a vehicle and in particular to an electronic key that may operate the vehicle with a discharged or nonfunctioning key battery.

Vehicles often have security systems to prevent inadvertent or unauthorized use of the vehicle. Traditionally, the security system was accomplished via a mechanical key. The vehicle's doors and activation systems had a corresponding mechanical lock that required the key to be inserted and rotated. When the key was turned in an ignition lock, a relay closes to complete an electrical starting circuit that activates the vehicle.

For convenience of users, door keys have, in some applications, been eliminated in favor of wireless remotes which allow the operator to unlock the door prior to arrival at the vehicle. These wireless remotes typically also function as a keychain which keeps the mechanical ignition/activation key coupled with the wireless remote. Other electronic keys have been developed which replace the mechanical key for both the door lock and the ignition/activation lock. These electronic keys typically have a wireless transponder such as a radio frequency identification device (RFID) that the vehicle detects and unlocks the door when the operator arrives. Similarly, the vehicle detects when the operator is in the vehicle and enables the vehicle to be started. Some electronic keys must be inserted into a slot in the dashboard before the vehicle will activate or start the engine.

Both the wireless remote and the electronic key have a small battery that allows the device to operate. In some of these devices, the housing of the key is sealed and the battery is not replaceable. The sealing of the key housing provides advantages by increasing security and preventing contaminants, such as water for example, from damaging electronic components. Unfortunately, when the battery level is below a threshold, the electronic key will not communicate with the vehicle and the operator will not be able to activate or start the engine. Replacement of the battery usually requires ordering a new electronic key from the manufacturer, which may take days or weeks to arrive. It should be appreciated that the failure of the electronic key may result in the operator being stranded in a remote or dangerous area without any means of starting their vehicle.

Accordingly, while existing electronic keys are suitable for their intended purposes the need for improvement remains, particularly in providing an electronic key that may be operated with a nonfunctioning battery or one at a low energy state.

### BRIEF DESCRIPTION OF THE DISCLOSURE

According to one embodiment of an exemplary embodiment, an electronic vehicle key includes a controller receptive to electrical power from both conductive transmission and inductive transmission. The controller has a processor that is responsive to executable computer instructions for controlling operation of the electronic vehicle key. The electronic vehicle key also includes a passive device configured to be receptive to a field external of the electronic vehicle key for inducing an electric current in the passive device. The passive device is in communication with the controller. The controller being configured and disposed to cause the passive device to transmit a radio-frequency signal as a result of the electric current induced in the passive device. The radio-frequency signal, when received at a vehicle, will enable activation of a vehicle feature.

According to another embodiment of an exemplary embodiment, a system includes a motor vehicle having an electronic control unit and a wireless device electrically connected to the electronic control unit. The system also includes an electronic vehicle key configured for communication with electronic control unit through the wireless device. The electronic vehicle key includes a controller receptive to electrical power from both conductive transmission and inductive transmission. The controller has a processor that is responsive to executable computer instructions for controlling operation of the electronic vehicle key. The electronic vehicle key also includes a passive device configured to be receptive to a field external of the electronic vehicle key for inducing an electric current in the passive device. The passive device is in communication with the controller. The controller is configured and disposed to cause the passive device to transmit a radio-frequency signal as a result of the electric current induced in the passive device. The radio-frequency signal, when received at the wireless device, will enable activation of a vehicle feature.

According to another aspect of an exemplary embodiment, a method of activating a vehicle feature of a motor vehicle includes receiving a field generated at the motor vehicle at a passive device arranged in an electronic vehicle key, inducing an electric current in the passive device in response to the field, communicating between the passive device and a controller arranged in the electronic vehicle key in response to the electric current, transmitting a radio-frequency signal from the passive device in response to the communicating between the passive device and the controller, wherein the vehicle feature is activated in response to receipt of the radio-frequency signal.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an electronic key, in accordance with an embodiment of the disclosure;

FIGS. 2A and 2B are schematic views of the electronic key, in accordance with embodiments of the disclosure;

FIG. 3 is a partial schematic view of a vehicle system that uses the electronic key of FIG. 1; and,

FIG. 4 is a flow chart for activating a vehicle with an electronic key, in accordance with an embodiment of the disclosure.

The detailed description explains embodiments of the disclosure, together with advantages and features, by way of example with reference to the drawings.

### DETAILED DESCRIPTION OF THE DISCLOSURE

Vehicles often utilize security systems to prevent unintended starting of the vehicle as well as unauthorized use. Electronic keys that transmit a wireless signal to the vehicle are a convenient device that allows the operator both access to the vehicle and activation of the vehicle power source. Embodiments of the present disclosure provide an electronic key that is capable of activating the vehicle when the key battery is nonfunctioning or at a low energy state. Other embodiments of the disclosure provide advantages in allowing recharging of the electronic key battery to maintain a desired energy state.

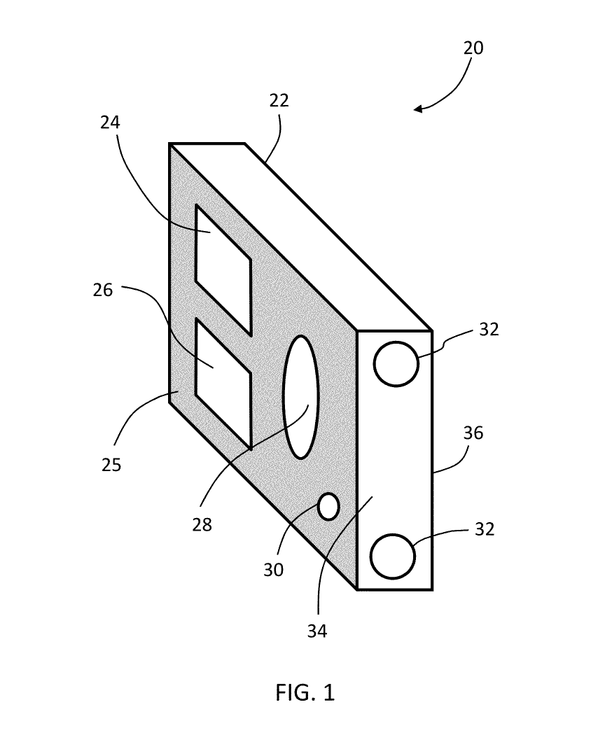

An electronic key 20 is shown in FIG. 1 that may be used with vehicles to unlock the vehicle door and also activate other vehicle systems such as the engine and the electronic controls, for example. The key 20 has a housing 22, which may have at least one button 24 on one side 25 for performing a function, such as unlocking the vehicle doors, when actuated. In the exemplary embodiment, the housing 22 may have a plurality of buttons 24, 26, 28 that may provide additional functionality to the user. For example, actuation of the buttons 24, 26, 28 may result in the opening of a trunk, starting of the car, activating an alarm, and locking doors. In one embodiment, the housing 22 may have an indicator 30, such as a light emitting diode (LED), for example, that provides a notification to the operator when there is an issue with the key 20, such as the battery energy state being ineffective for performing a desired function. The housing 22 and buttons 24, 26, 28 may be made from a suitable plastic material, such as, but not limited to, polycarbonate, polypropylene, and high-density polyethylene for example.

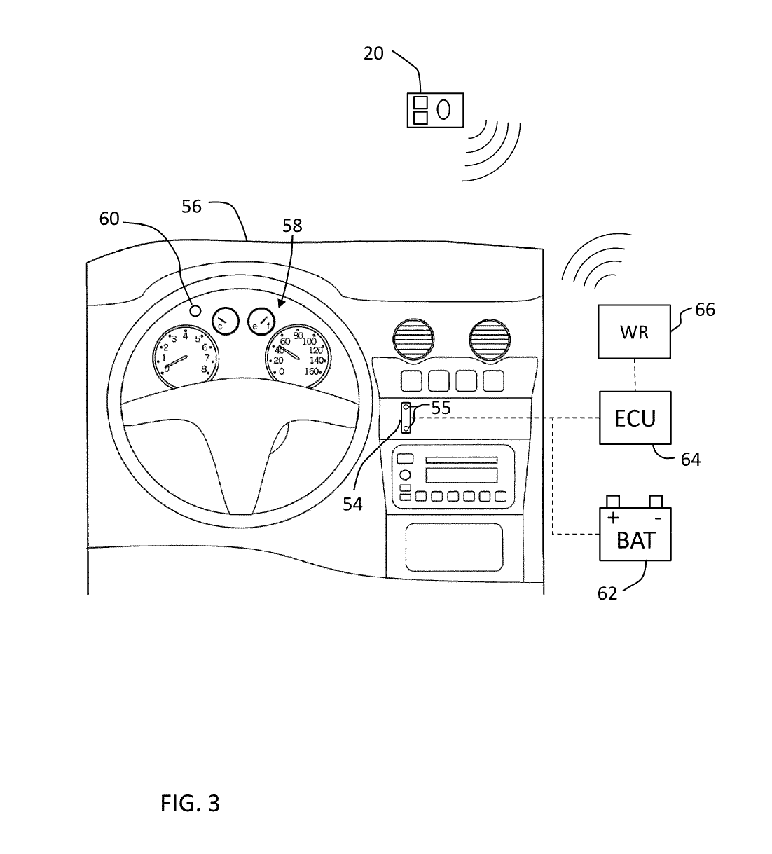

The key 20 further includes a connecting circuit 48, which in the present exemplary embodiment is a pair of contacts 32. As will be discussed in more detail below, the contacts 32 are disposed in the housing 22 and at least partially exposed to the external environment to allow the contacts 32 to be electrically coupled to a receptacle 54 (FIG. 3) to provide electrical power to the key 20. Further, it should be appreciated that while embodiments herein describe the pair of contacts 32 as being disposed on an end 34 of the housing 22, this is for exemplary purposes and the claimed disclosure should not be so limited. In other embodiments, the contacts 32 may be disposed along an edge, a side 36 opposite the buttons, or on the side 25 of the buttons. Further, the pair of contacts 32 may be any suitable shape, such as round, square, or rectangular, for example. Further, the key 20 may have additional contacts that allow for other functionality, such as data communication for example, when the key 20 is received in a corresponding receptacle for example.

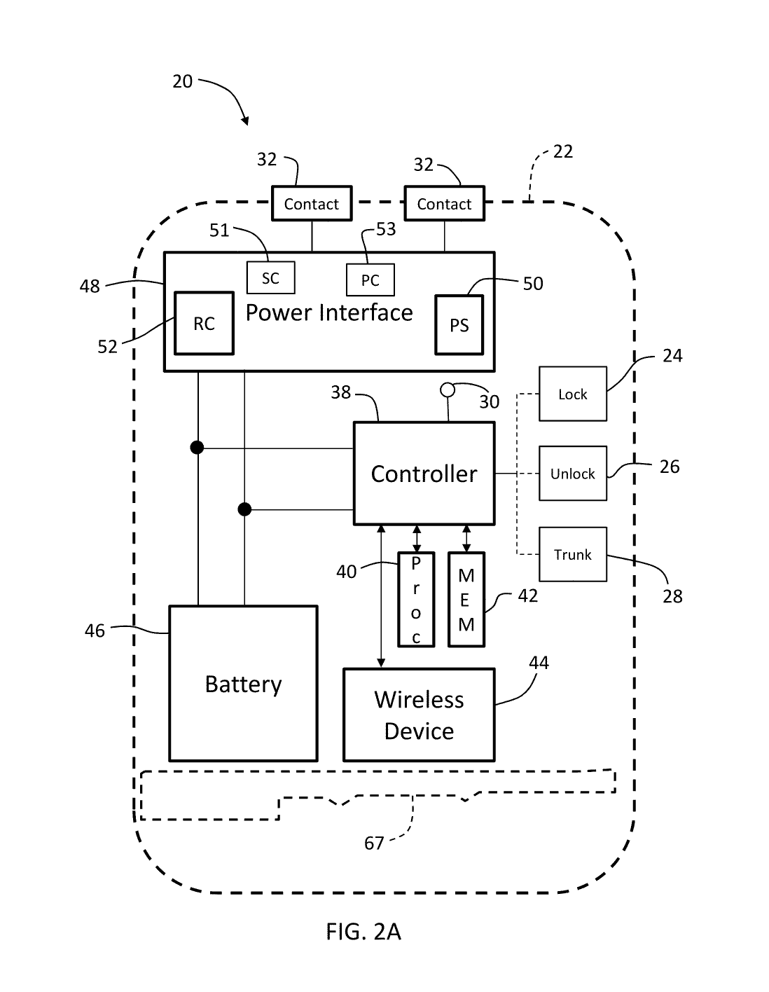

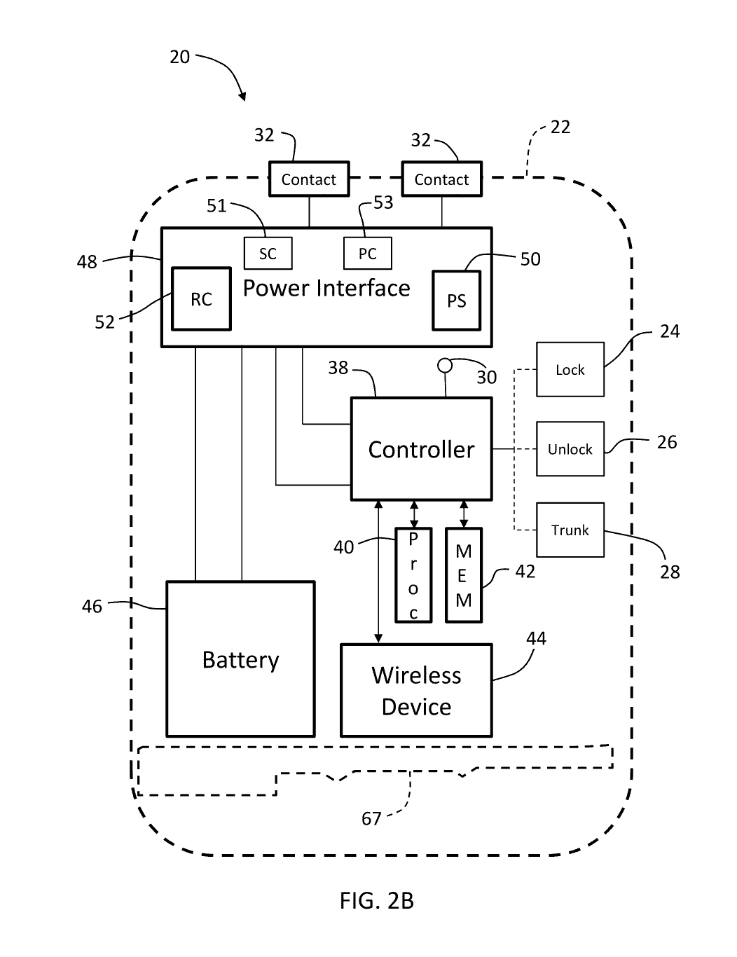

The key 20 further includes several components shown in FIGS. 2A and 2B that are arranged within the housing 22. A controller 38 is arranged within the housing 22. In the exemplary embodiment, the controller 38 includes a processor 40 that provides the desired control functionality and controls the operation of the key 20. The controller 38 is a suitable electronic device capable of accepting data and instructions, executing instructions to process data and transmitting a resulting signal. The controller 38 may accept instructions through the buttons 24, 26, 28 or through other means, such as radiated wavelength and electronic or electrical transfer. The controller 38 may be, but is not limited to, a microprocessor, a complex instruction set computer, an application specific integrated circuit (ASIC), a reduced instruction set computer, or the like.

The controller 38 is capable of converting analog voltage or current levels into digital signals. The controller 38 uses the digital signals for processing and to act as input to various processes for controlling the key 20. The controller 38 is operably coupled with one or more components of the key 20 such as memory 42 and a wireless device 44. The wireless device 44 may be a transceiver (e.g. capable of receiving and transmitting signals), that actively transmits and receives signals, an active transmitter only, or may be a passive device that transmits a signal in response to an external magnetic field that induces an electrical current in the device.

The wireless device 44 may be, but is not limited to: an RFID device, a Bluetooth® device, a radio-frequency device, or an IEEE 802.11 compliant device for example. In one embodiment, the wireless device 44 is a rolling code type transmitter that prevents unauthorized persons from acquiring the codes for opening or activating the vehicle.

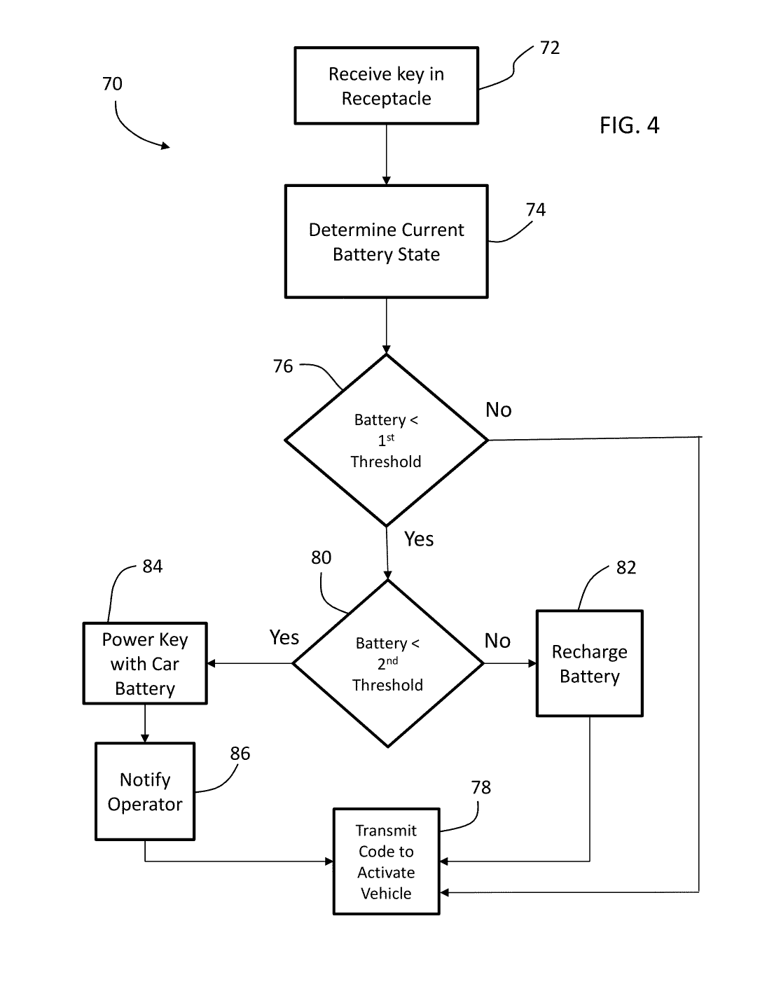

Controller 38 includes operation control methods embodied in application code, such as shown in FIG. 4 for example. These methods are embodied in computer instructions written to be executed by processor 40, typically in the form of software. The software can be encoded in any suitable computer programming language, such as C++ for example.

The controller 38 and wireless device 44 are powered by a battery 46 arranged within the housing 22. The battery 46 provides electrical power needed by the key 20 during operation. The battery 46 may be any suitable energy storage device capable of storing an electrical charge and discharging to an electrical circuit such as a dry-cell type battery for example. In one embodiment, the battery 46 may be a re-chargeable storage device, such as, but not limited to, a lithium-ion battery or a nickel-cadmium battery for example.

An interface circuit 48 is electrically coupled between the contacts 32 and the controller 38. Power to other electrical components of the key 20 can be sourced from the controller 38 or the interface circuit 48. In one embodiment the interface circuit 48 includes a power sensing circuit 50 that senses the power level of the battery 46. Alternatively, the controller 38 can be configured to sense the power level of the battery 46. Such power sensing circuitry is well known for sensing voltage and current levels provided by a battery. In the case where the battery 46 is of the type that emulates an open circuit condition in a low power state, the battery 46 can be electrically connected to both the interface circuit 48 and the controller 38, as is shown in FIG. 2A. When the sensed power level is below a threshold, a switch circuit 51 of the interface circuit 48 switches or changes state to allow electrical power received at the contacts 32 to flow into the electronic key 20. However, in the case where the battery 46 is of the type that emulates a closed or short circuit condition in a low power state, the battery 46 is electrically connected to the interface circuit 48 and not directly to the controller 38, as shown in FIG. 2B. In the embodiment shown in FIG. 2B, the battery 46 power is sensed at the power sensing circuit 50 of the interface circuit 48. When the sensed electrical power level is at a level where the key 20 is ineffective, the switch circuit 51 of the interface circuit 48 switches from electrical power received from the battery 46 to electrical power received at the contacts 32. It should be appreciated that a power level that is ineffective is one where the key 20 does not have sufficient electrical power to carry out the intended functions (e.g. activate the vehicle). The interface circuit 48 may include a power conditioning circuit 53 if the electrical power provided to the contacts 32 needs to be conditioned to power the electrical components of the key 20. Such power conditioning is well known and simply converts the electrical power signals to desired voltage levels. However, if the electrical power provided to the contacts 32 does not need to be conditioned to power the electrical components of the key 20, then the power conditioning circuit 53 can be avoided.

While the switch circuit 51 has been described as an electronic switch, it is within the scope of the disclosure that the switch circuit 51 is a mechanical switch that would electrically connect the contacts 32 to components (e.g., the controller 38) of the key 20. The mechanical switch could be a simple slide-type switch on the key 20 that is manually actuated by the operator when the key 20 does not function. In such an exemplary embodiment, the use of the power sensing circuit 50 could be avoided.

In one embodiment the interface circuit 48 includes a recharging circuit 52 that recharges the battery 46. Such recharging circuitry is well known for sensing voltage and current levels provided by a battery. In such embodiments the battery 46 is a rechargeable battery. In this embodiment, the recharging circuit 52 of the interface circuit 48 receives power from the contacts 32 and then provides recharging power to the battery 46. Alternatively the controller 38 can be configured to recharge the battery 46 from power received at the contacts 32 through the interface circuit 48. The interface circuit 48 may be configured to simultaneously power the key 20 and recharge the battery 46. In still other embodiments, the interface circuit 48 may be configured to only power the controller 38 when the battery 46 is below a threshold or nonfunctioning. In yet still other embodiments, the interface circuit 48 may be configured to only recharge the battery 46.

In one embodiment, the connecting circuit 48 may be an inductive circuit that allows electrical power to be transferred from the vehicle to the key 20. An inductive circuit is well known as a means for transferring electrical power through magnetic fields without a conductive connection.

The housing 22 is sized and shaped to be received within a receptacle 54 (FIG. 3) in the vehicle. The receptacle 54 may be positioned in a convenient place for the operator, such as the dashboard 56, as shown in FIG. 3 for example. In other embodiments, the receptacle 54 may be placed within a compartment, such as a center console, an armrest or a glove compartment for example. The receptacle 54 includes another connecting circuit 48, which in the present exemplary embodiment is a pair of contacts 55 that are configured to engage the pair of contacts 32 when the key 20 is inserted into the receptacle 54. However, in the embodiment described herein where the connecting circuit 48 of the key 20 is an inductive circuit, the connecting circuit 48 at the receptacle 54 would also be an inductive circuit. The pair of contacts 32 may have a biasing, or spring loaded, feature to ensure electrical connection when the key is inserted. Such biasing features are well known in electronic devices. In one embodiment, the vehicle has an instrument panel 58 that includes an indicator 60 that may be used to alert the operator that there is an issue with the battery 46, such as needing to be recharged or replaced for example.

The receptacle 54 is electrically connected to a vehicle battery 62. It should be appreciated that there may be one or more electrical components, such as relays, transformers, and fuses for example, that may be coupled between the vehicle battery 62 and the receptacle 54. This connection allows electrical power from the vehicle battery 62 to be transferred to the key 20 to recharge the battery 46, power the controller 38, or a combination thereof. It should be appreciated that in embodiments where the contacts 32 form an inductive circuit, the receptacle 54 may be a recessed area or other space (e.g. a drawer, an armrest or center console compartment) in which the operator places the key 20.

The receptacle 54 may further be connected for communication to an engine control unit 64 (ECU). Communication between the receptacle 54 and the ECU 64 may be direct, meaning that the signals, such as an activation enable signal or a battery low signal, for example, may be passed directly from the key 20 to the ECU 64. In another embodiment, the connection may be indirect, meaning that the ECU 64 may infer that there is an issue with the battery 46 since the vehicle battery 62 is providing electrical power to the key 20. The vehicle may further include a wireless device 66 that is configured to receive signals from the key 20. In one embodiment, the key 20 and the wireless device 66 are configured for bi-directional asynchronous communication. In one embodiment, the communication between the key 20 and the ECU 64 is via contacts 32 and 55 when the key 20 is inserted in the receptacle 54. In a further embodiment, the wireless device 66 and the key 20 may communicate using a suitable communications protocol, such as that defined by the IEEE 802.11 standard, the Bluetooth® standard for example.

With the electronic key 20 inserted in the receptacle 54, the electronic key 20 has electrical power even with a low battery 46 state or a defective battery 46. With the electronic key 20 energized, the vehicle may be operated. It should be appreciated that the operator may still desire to replace the electronic key 20 since the wireless door unlock functionality may not function. However, until the operator is able to obtain a replacement, the operator would still be able to unlock the vehicle doors with low or defective battery 46 using a slide out mechanical key 67, such as are found with electronic keys. Thus, the vehicle is always available and the probability of the operator becoming stranded in a remote or dangerous location due to an inoperable electronic key is reduced or eliminated.

Referring now to FIG. 4, a method 70 is shown of the operation of an electronic key 20 having a rechargeable battery. The method 70 starts with receiving 72 the key 20 in the receptacle 54. The method 70 then determines 74 the current energy state of the battery 46. In other embodiments, the state of the battery 46 may be checked on a periodic or aperiodic basis even when the key 20 is not in the receptacle 54. In these embodiments, the controller 38 may activate the indicator 30 when the battery energy state is below a desired threshold. With the energy state determined, the method 70 then proceeds to compare 76 the battery energy state to determine if it is less than a first threshold. If the energy state is above the threshold, then the energy state is more than adequate for operation and does not need to be recharged. Some types of rechargeable batteries have operating parameters that determine when to recharge the battery for enhanced battery life. For example, some types of batteries have a memory affect which results in a loss of capacity if they are recharged with a high level of energy remaining. The first threshold may represent an energy state of 25% of the battery capacity for example.

If the comparison of the battery energy state with the first threshold is a negative, the method 70 proceeds to transmit 78 the activation code to the vehicle. If the comparison results in a positive, the method 70 proceeds to compare 80 the battery energy level to determine if it is less than a second threshold. This second threshold represents an energy state below which the key 20 may not operate correctly and may be nonfunctional. If this comparison 80 has a negative result, the key 20 proceeds to recharge 82 the battery 46 and transmits 78 the activation code.

If the comparison with the second threshold results in a positive, meaning that the battery 46 is ineffective or not sufficient for operation, the method 70 then configures the interface circuit 48 to power 84 the controller 38 using electrical power from the vehicle that is received via receptacle 54. In one embodiment, the electrical power is supplied directly to the controller 38. In another embodiment, the electrical power to operate the controller 38 flows through the battery 46. In one embodiment, when the key 20 (having a nonfunctioning battery) is provided with sufficient electrical power to operate, the operator is notified 86 via the indicator 30, an audio signal, the indicator 60, or a combination thereof before proceeding to transmit 78 the activation code to the vehicle.

Embodiments of the present disclosure provide advantages in allowing an electronic key to activate a vehicle when its battery is ineffective, low, or nonfunctioning. Still further embodiments of the present disclosure provide advantages in allowing a battery in an electronic key to be recharged by a vehicle during operation.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An electronic vehicle key comprising:
a controller receptive to electrical power from both conductive transmission and inductive transmission, the controller having a processor that is responsive to executable computer instructions for controlling operation of the electronic vehicle key; and
a passive device configured to be receptive to a field external of the electronic vehicle key for inducing an electric current in the passive device, the passive device being in communication with the controller, the controller being configured and disposed to cause the passive device to transmit a radio-frequency signal as a result of the electric current induced in the passive device, wherein the radio-frequency signal when received at a vehicle will enable activation of a vehicle feature.

2. The electronic vehicle key of claim 1, further comprising:
a battery in communication with the controller for providing the electrical power from conductive transmission.

3. The electronic vehicle key of claim 1, wherein the vehicle feature comprises an engine.

4. The electronic vehicle key of claim 1, wherein the vehicle feature comprises a door lock.

5. The electronic vehicle key of claim 2, wherein the battery is a rechargeable battery.

6. A system comprising:
a motor vehicle including an electronic control unit (ECU), and a wireless device electrically connected to the electronic control unit; and
an electronic vehicle key configured for communication with electronic control unit through the wireless device, the electronic vehicle key comprising:
a controller receptive to electrical power from both conductive transmission and inductive transmission, the controller having a processor that is responsive to executable computer instructions for controlling operation of the electronic vehicle key; and
a passive device configured to be receptive to a field external of the electronic vehicle key for inducing an electric current in the passive device, the passive device being in communication with the controller, the controller being configured and disposed to cause the passive device to transmit a radio-frequency signal as a result of the electric current induced in the passive device, wherein the radio-frequency signal when received at the wireless device will enable activation of a vehicle feature.

7. The system of claim 6, further comprising: a battery in communication with the controller for providing the electrical power from conductive transmission.

8. The system of claim 6, wherein the vehicle feature comprises an engine.

9. The system of claim 6, wherein the vehicle feature comprises a door lock.

10. The system of claim 9, wherein the battery is a rechargeable battery.

11. A method of activating a vehicle feature of a motor vehicle comprising:
receiving a field generated at the motor vehicle at a passive device arranged in an electronic vehicle key;
inducing an electric current in the passive device in response to the field;
communicating between the passive device and a controller arranged in the electronic vehicle key in response to the electric current; and
transmitting a radio-frequency signal from the passive device in response to the communicating between the passive device and the controller, wherein the vehicle feature is activated in response to receipt of the radio-frequency signal.

12. The method of claim 11, further comprising: powering the controller through a battery arranged in the electronic vehicle key.

13. The method of claim 11, wherein the transmitting the radio-frequency signal from the passive device to activate the vehicle feature includes activating operation of a vehicle engine.

14. The method of claim 11, wherein the transmitting the radio-frequency signal from the passive device to activate the vehicle feature activating operation of a door lock.
